(19) United States
(12) Patent Application Publication
(10) Pub. No.: US 2010/0185976 A1
(43) Pub. Date: Jul. 22, 2010

(54) Graphic user interface and a method thereof

(76) Inventor: Sairam Sadanandan, Bangalore (IN)

Correspondence Address: HARNESS, DICKEY & PIERCE, P.L.C., P.O.BOX 8910, RESTON, VA, 20195, US

(21) Appl. No.: 12/320,192

(22) Filed: Jan. 21, 2009

(51) Int. Cl. G06F 3/048

(52) U.S. Cl. 715/786

(57) ABSTRACT

An embodiment of the present invention relates to a graphical user interface for managing data sets. A graphic user interface includes a scroll bar for virtually representing a size of data being visualized in the graphic user interface window and a plurality of slider controls positioned in the scroll bar. The plurality of slider controls are moved for controlling simultaneous visualization of data on a plurality of sections in the graphic user interface.

### FIELD OF INVENTION

The present invention relates to a graphical user interface, and more particularly, to a graphical user interface for managing data sets.

### BACKGROUND OF INVENTION

Graphical user interfaces are typically based on graphic display technology that employs pictorial representations, typographic-styled text and other graphical representations on a display screen of a computer system. A graphical user interface (GUI) includes a window environment that configures the screen to resemble a graphical display for a user to enter or view information. Generally, an application program executing on the computer system presents the information to the user through this windows by drawing images, graphics or text within the window region. The user, in turn, communicates with the application by ‘pointing’ at controls within the window region via a user input means, such as a mouse. However, a GUI is limited by the available space on a computer screen, as well as the amount of data that it needs to visualize.

When the GUI window area is far smaller than the whole dataset that is being visualized then a scroll bar is used. The scroll bar consist of a bar that virtually represents the size of the data set being visualized and a slider control that is moved along the scroll bar thereby changing the section of data that is being viewed. The size of the slider control is a function of the GUI display area, to the size of display area for the whole dataset. So the slider would become shorter when a smaller area of data is displayed and larger when more of the data is displayed.

For example, while visualizing volumetric data in volumetric data analysis, different regions of interest needs different color representation, so that they are easily distinguishable. Existing interfaces available for manipulating of this data are usually complex. Say for example manipulation of visibility of these different segments using existing GUI controls involves usually user interfaces with several independent controls and take up costly real estate in the display area and may also involve complex predefined sequential workflows that are difficult for non-expert users. Since existing GUI widgets or controls cannot be overloaded with multiple functionalities and still retain their intuitiveness, existing solutions uses multiple GUI widgets to deal with such data set. The UI itself will take lot of screen space or can even obscure the image in case it is a popup dialog.

### SUMMARY OF INVENTION

In view of the foregoing, an embodiment herein includes a graphical user interface, comprising a scroll bar for representing a data set; and a plurality of slider controls positioned in said scroll bar, each slider control defining a section of the data set.

Additionally, in a further preferred embodiment, a method is explained for providing a graphical user interface window, comprising the steps of representing a data set using a scroll bar; and positioning a plurality of slider controls in said scroll bar, each slider control defining a section of the data set. This enables the user of the interface, to flexibly control and manipulate the whole data set for achieving a set result. The multiple slider control can virtually represent any data, any process or any parameter information enabling the invention to be used in a simple visualization of data to a complex scenario of controlling process in some manufacturing or processing industries. Additionally, a scrollbar with more than one slider control can combine functions which usually would have required more than one scrollbar, thereby saving space on a computer screen.

In another embodiment, the plurality of slider controls are selectively positioned at a plurality of locations in the scroll bar thereby simultaneously visualizing corresponding sections in the data set defined by said plurality of slider controls in the graphical user interface. This helps a user to control or manage different portions of the data set. In a practical scenario, the plurality of slider controls can represent a section of a data set or a sub-process in an industrial process, parameter associated with elements associated with an image during image processing etc.

In a further preferred embodiment, simultaneously visualizing corresponding sections in the graphical user interface involves overlaying data associated with said sections. Overlaying data associated with the sections enable to perform data comparisons much faster and accurate, for example when doing a data or any other process analysis.

In an alternative embodiment, the scroll bar is adapted to be positioned with equal sized plurality of slider controls. For example, this facilitates the comparison of the data in a fixed range of the dataset.

In an alternative embodiment, pluralities of slider controls are adapted to be merged to form a single slider control. This facilitates more user friendly management of the dataset by decreasing the number of sliders which the user has to handle.

In an alternative embodiment, the plurality of slider controls are adapted to be overlapped. The said overlapping enables overlaying of data represented in the sections defined by the slider control facilitating effective control or representation of the data set. The overlay could be a partial or a full overlay depending upon the requirement.

In an alternative embodiment, the slider control further comprises a first sub area to change the size of said slider control, thereby correspondingly changing the section defined by the slider control. This helps in varying the visualized data content associated with a section defined by a slider control in the graphical user interface or to vary any other parameter associated with the slider control.

In an alternative embodiment, the slider control is adapted to be split into a plurality of sub-slider controls, wherein a sub-slider control is selectively positioned in the scroll bar to select at least one sub section of the data set. This helps in effective management of the data set, giving the user more freedom to manipulate different portions of the data set.

In an alternative embodiment, the data set is a plurality of parameters. Additionally, the slider control further comprises a second sub area adapted to be moved in relation to said slider control to change the transparency index of a parameter in the plurality of parameters. For, example there can be different parameters linked to an industrial process. The application of the said inventive concept will enable specific parameters involved in the processes to be controlled simultaneously using just one scrollbar in the graphical user interface.

In an alternative embodiment, the slider controls are adapted to specify parameters, wherein said parameters are associated with the display of an image. For, example in image analysis or in image processing, the parameter could be information related to a color or plurality of colors which need to be filtered from the image to get a required image for the said analysis. This enables the user to flexibly manipulate the parameters.

### BRIEF DESCRIPTION OF THE DRAWINGS

The present invention is further described hereinafter with reference to exemplary embodiments shown in the accompanying drawings, in which:

FIG. 1 is an illustration showing a graphical user interface in accordance with the present invention;

FIG. 2 illustrates a graphical user interface in accordance with an embodiment where the pluralities of slider controls are adapted to be overlapped;

FIG. 3 illustrates a graphical user interface in accordance with an embodiment where the size of a slider control is varied; and

FIG. 4 illustrates a graphical user interface in accordance with an embodiment wherein the data set is defined by a color scale.

### DETAILED DESCRIPTION OF INVENTION

Prior to describing the operations of Graphical User Interface (GUI), some of the terminology used herein will be explained. “Graphical User Interface” is a component of an operating system or an application that presents the user, an interface on the monitor and thereby enabling the user to control a computer. The “Graphical User Interface” is also defined as a control panel in an application enabling the user to adjust settings on the computer. “Transparency index” refers to the variable properties of color such as brightness or contrast associated with an image. “Data Set” refers to a collection of related data records on a storage device. The data could be numeric, alpha numeric, or any other form of information for example color, gray scale, graphical data information, time line etc.

A multi-slider as a control is a new take on the traditional scrollbar control. Here the user can have multiple slider controls, which, for example, correspond to a specific range of data in a dataset. The applications view, can then use the position and size of each slider to show the corresponding data in its view. While the traditional single slider is used to visualize only the part of the data set that occur together, the multi-slider can simultaneously visualize data from different sections of the data set.

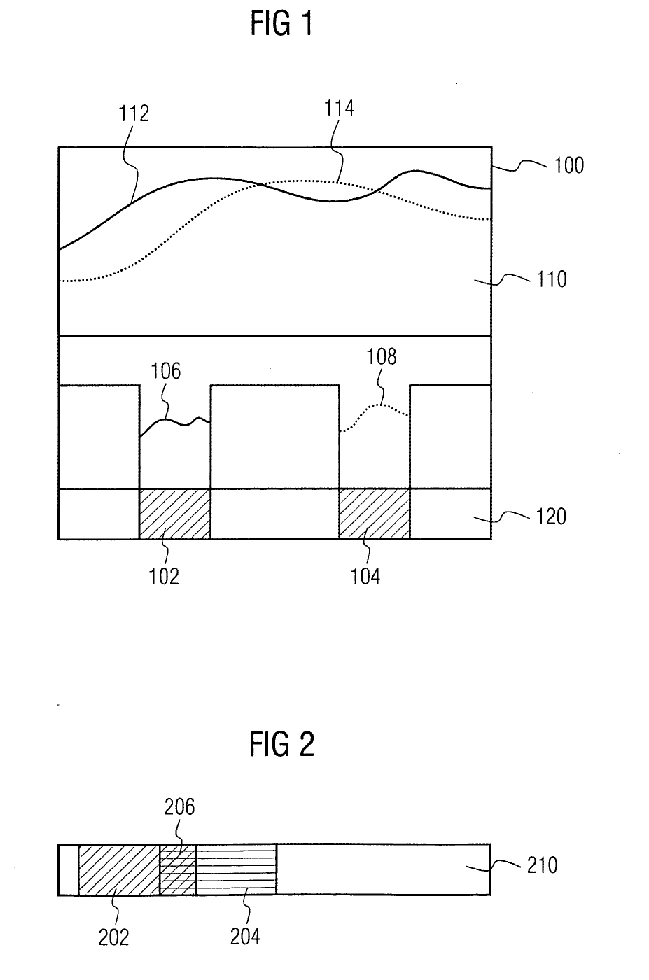

FIG. 1 illustrates a graphical user interface window 100 in accordance with the present invention. A first slider control 102 and a second slider control 104 are positioned in the scroll bar 120 at different locations. The first slider control 102 defines a section in the data set and which is visualized as section data 106 and the second slider control 104 defines another section in the data set and is visualized as section data 108. The positioning of the first slider control 102 and the second slider control 104 is translated into a comparison chart 110 comprising a first graph 112 and a second graph 114 corresponding to the respective section data 106 and section data 108. For example the data could be some financial data, geographical data, etc that need to be compared since they are available at two distinct periods in time.

As a practical application, this multiple slider control could be used in a interface which can control an industrial process. For example in an industrial process, where two distinct sub-processes have to be performed in two distinct periods in time. The multi slider controls can be utilized to initiate the start, end or to control or set the duration of the processes, thereby controlling the whole process. This could be made possible by taking the scrollbar as the time line and considering each sliding control as a specific process that need to be run to get the end result. Each slider corresponds to a certain period, depending on the position and the length of the slider. Each slider can be assigned to a same or different kind of sub process. For controlling a process it is not required to display any additional information like graphical representation of data related to the process in addition to the scrollbar. However, such graphical representation of data which is relevant for the process will be helpful to adjust the sliders appropriately.

Using this Graphical User interface, a user can simultaneously visualize data associated with the corresponding sections i.e. section data 106 and section data 108 as an overlay as shown in FIG. 1. Here, the graphical user interface involves overlaying data associated with said sections. Overlaying data associated with the sections enable to perform operations for example like data comparisons much faster and accurate.

Additionally, the scroll bar is adapted to be positioned with equal sized plurality of slider controls. For example, this facilitates the comparison of the data in a fixed range of the dataset. For example, while performing a financial data analysis, the user needs to compare financial data for the same quarter for two different years. In this case, the user can position the slider controls on the respective quarters in the respective years. The visualization of the information in the user interface can give a clear understanding of the results in the two quarters. Here a change in a slider size also can be made dependent on one another. The amount of change in the size made on one slider control affects the size of the other slider control, thereby automatically moving the other slider the same amount. Thus managing data becomes easier.

Additionally, plurality of slider controls are adapted to be merged to form a single slider control. This facilitates more user friendly management of the dataset by decreasing the number of sliders which the user needs to handle.

In another embodiment, plurality of slider controls are adapted to be overlapped. The said overlapping enables overlaying of data represented in the sections defined by the slider control, thereby facilitating effective control of the data set. FIG. 2 explains a scenario, in a manufacturing industry, where a process A has to start prior to starting a process B, but the process B has to start prior to the end of process A. In this case, the scroll bar 210 virtually represents the timeline for the whole process, and process A and process B are any two of the sub-process in a plurality of sub-processes. Here the process A is represented by the slider control 202 and the process B is represented by slider control 204. The merged portion 206 shows the time span when both the processes are performed simultaneously. Thus the user can use multiple slider controls to conveniently control the processes.

In an alternative embodiment, the slider control further comprises a sub-area to change the size of said slider control, thereby correspondingly changing the section defined by the slider control. The sub area could be a corner portion of the slider control. This helps in varying the visualized data content associated with a section defined by a slider control in the graphical user interface if this is used for data visualization or vary any other parameter associated with said slider control.

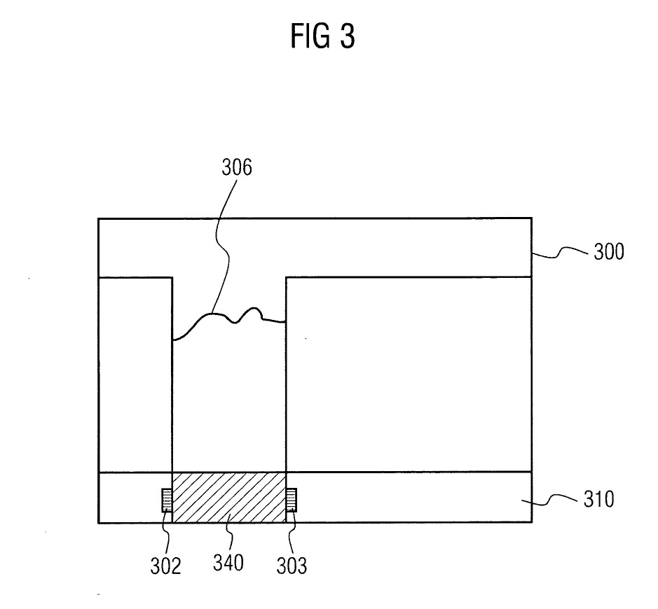

FIG. 3 illustrates a graphical user interface 300, comprising a mechanism to vary the size of a slider control. The slider control 102 explained in FIG. 1 is shown extended to a slider control 340 in FIG. 3. The slider control 340 comprises sub-area 302 and sub-area 303, which is used to change the size of the slider control to vary the visualization of data associated with the section defined by the slider control. Section data 306 can be varied by moving the sub-areas, along side the scroll bar 310. The said sub-areas are moved or dragged by a pointing device along side the scroll bar in either directions or to a single direction to change the size of the slider control 340. While moving, if the sub-area 302 and sub-area 303 at either sides of the slider control is brought close to each other to minimize the distance between them to zero, then the data get masked, i.e. no data is visualized in the GUI window. Thus this helps in managing the visualization.

A slider control is adapted to be split into a plurality of sub-slider controls. This helps in effective management of the data set, giving the user more freedom to manipulate different portions of the data set according to the specific requirement. These sub-slider controls can be selectively positioned in the scroll bar to select the respective sub-sections of data set. The slider control splitting is practically implemented using various methods, one of which is through context menus. The splitting can also be implemented by performing a double click in the pointing device like mouse or even by drawing a virtual line on the sliding control, wherein the line indicates where the sliding control should be separated into two individual sliders.

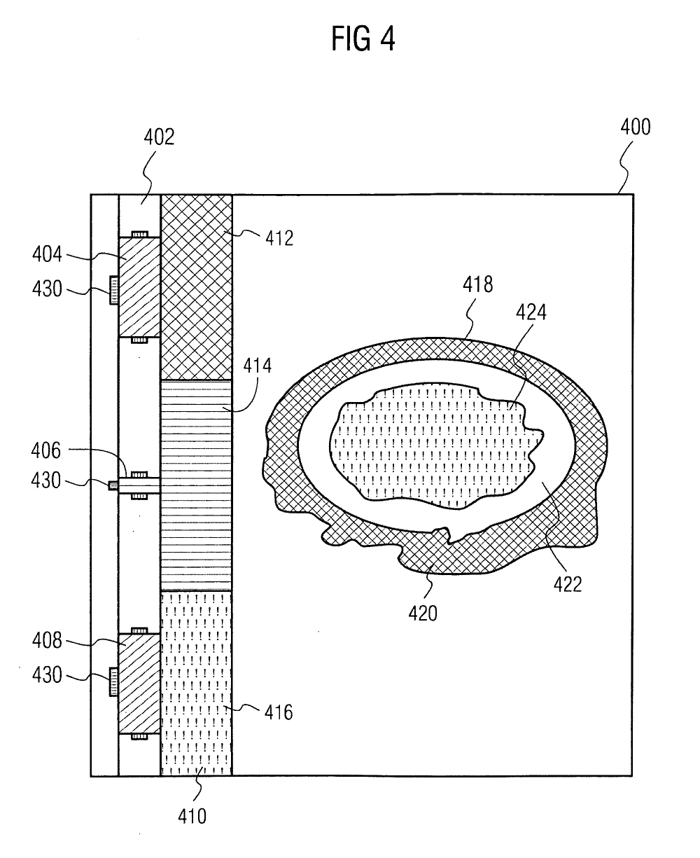

FIG. 4 illustrates a graphical user interface window 400 in accordance with an embodiment wherein the data is a specific parameter in a plurality of parameters, for example, a color in a color scale. The graphical user interface window 400 comprises of a scroll bar 402. The scroll bar 402 is shown comprising of a first slider control 404, a second slider control 406 and a third slider control 408. The position and length of the slider controls 404, 406 and 408 specify a certain section of the color scale which is represented by the entire scrollbar. For example, the first slider control 404 covers a color range in the yellow color spectrum, the second slider control 406 selects a section of the green color spectrum and the range of the third slider control 408 relative to the total length of the scroll bar 402 corresponds to a part of the blue color spectrum. All these three disjoint sections of the full color spectrum together specify a color filter which can be applied to an image. Only pixels of the image which are comprised within said sections will be displayed. Of course the filter can be used in the opposite way, i.e. only pixel of the image which are not comprised within one of the sections specified by the slider controls 404, 406 and 408 will be displayed.

The practical application of the multiple slider controls and color scale is also shown in the FIG. 4, where visualization of volumetric medical data or post processing applications, involve setting different organs or regions of interest to different colors so that they are easily distinguishable. For example, the image shown in FIG. 4 is a cross sectional view of a human head containing different elements like skin, bone and brain. The image 418 shows a cross sectional view of a human head where a volumetric image analysis need to be performed. In this image 418, elements like the skin 420, the bones 422 and the brain 424 have to be distinctly distinguished to the user to perform said analysis. This is made possible by allocating specific colors to said elements and associating each color with a specific slider control. This association can be created by moving the slider control along the scroll bar and aligning the slider control with the required color so as to select the said color. In the image 418, the skin 420 is visualized in color yellow 412 by moving the associated first slider control 404 along the scroll bar 402 and positioning the slider control close to the color yellow 412 so as to select the said color. Also, the brain 424 is visualized in blue color by moving the associated third slider control 408 along the scroll bar 402 and positioning the said slider control close to the color blue 416 so as to select the said color. By varying the size of the slider control to the minimum, it is possible to mask an associated color which is configured to a specific element. This provides the user enormous flexibility for the analytical study of the image. Here the side of the slider control 406 is minimized to mask the color associated with the bones 422.

In practical scenarios, image viewing of a specific single element require masking of other unwanted elements while the specific element is visualized and analyzed. The interface for manipulating the visualization of different elements like skin, bone or brain is managed using the multi-slider. Here the color scale is constructed for the valid colors in the dataset. The multi-slider is mapped against the color scale which could be further mapped to a specific element or organ. Only colors where the slider is positioned will be rendered visible in the view. The color scale and the multi slider sit on an edge of the image, resembling an overlay for the image/view, and thus consume very less space of the imaging layout. Moving the slider control along the scroll bar enables the selection of the color which will be rendered visible. There is a sub-area 430 associated with each slider control which is moved in relation to the respective slider controls which changes the transparency index of the color depicted in the image. The transparency index for example reflects the brightness or the contrast of the color. For example, the transparency index of color yellow 412 of the skin 420 in the image is changed by moving the sub-area 430 associated with the corresponding first slider control 404 in relation with said slide control.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A graphical user interface, said graphic user interface comprising:
a scroll bar for representing a data set; and
a plurality of slider controls positioned in said scroll bar, each slider control defining a section of the data set.

2. The graphical user interface according to claim 1, wherein the plurality of slider controls are selectively positioned at a plurality of locations in the scroll bar thereby simultaneously visualizing corresponding sections in the data set defined by said plurality of slider controls in the graphical user interface.

3. The graphical user interface according to claim 2, wherein simultaneously visualizing corresponding sections involves overlaying data associated with said sections.

4. The graphical user interface according to claim 1, wherein the scroll bar is adapted to be positioned with equal sized plurality of slider controls.

5. The graphical user interface according to claim 1, wherein the plurality of slider controls are adapted to be merged to form a single slider control.

6. The graphical user interface according to claim 1, wherein the plurality of slider controls are adapted to be overlapped.

7. The graphical user interface according to claim 1, wherein the slider control further comprises a first sub area to change the size of said slider control, thereby correspondingly changing the section defined by the slider control.

8. The graphical user interface according to claim 1, wherein the slider control is adapted to be split into a plurality of sub-slider controls, wherein a sub-slider control is selectively positioned in the scroll bar to select at least one sub section of the data set.

9. The graphical user interface window according to claim 1, wherein the data set is a plurality of parameters.

10. The graphical user interface window according to claim 9, wherein the slider control further comprises a second sub area adapted to be moved in relation to said slider control to change the transparency index of a parameter in the plurality of parameters.

11. The graphical user interface window according to claim 9, wherein the slider controls are adapted to filter the parameters, wherein said parameters are associated with an image.

12. A method for providing a graphical user interface window, comprising the steps of:
representing a data set using a scroll bar; and
positioning a plurality of slider controls said scroll bar, each slider control defining a section of the data set.

13. The method as claimed in claim 12, wherein the plurality of slider controls are selectively positioned at a plurality of locations in the scroll bar thereby simultaneously visualizing corresponding sections in the data set defined by said plurality of slider controls in the graphical user interface.

14. The method as claimed in claim 13, wherein simultaneously visualizing corresponding sections involves overlaying data associated with said sections.

15. The method as claimed in claim 12, wherein the scroll bar is adapted to be positioned with equal sized plurality of slider controls.

16. The method as claimed in claim 12, wherein the plurality of slider controls are adapted to be merged to form a single slider control.

17. The method as claimed in claim 12, wherein the plurality of slider controls are adapted to be overlapped.

18. The method as claimed in claim 12, wherein the slider control further comprises a first sub-area to change the size of said slider control, thereby correspondingly changing the section defined by the slider control.

19. The method as claimed in claim 12, wherein the slider control is adapted to be split into a plurality of sub-slider controls, wherein a sub-slider control is selectively positioned in the scroll bar to select at least one sub section of the data set.

20. The method as claimed in claim 12, wherein the data set is a plurality of parameters.

21. The method as claimed in claim 20, wherein the slider control further comprises a second sub area adapted to be moved in relation to said slider control to change the transparency index of a parameter in the plurality of parameters.

22. The method as claimed in claim 20, wherein the slider controls are adapted to filter the parameters, wherein said parameters are associated with an image.
